(19) United States
(12) Patent Application Publication
(10) Pub. No.: US 2024/0109265 A1
(43) Pub. Date: Apr. 4, 2024

(54) Systems and Methods for Making Membrane Surfaces

(71) Applicant: L'Garde, Inc., Tustin, CA (US)

(72) Inventor: Arthur L. Palisoc, Irvine, CA (US)

(21) Appl. No.: 18/539,027

(22) Filed: Dec. 13, 2023

Related U.S. Application Data
(63) Continuation of application No. PCT/US2022/073270, filed on Jun. 29, 2022.
(60) Provisional application No. 63/216,456, filed on Jun. 29, 2021.

(51) Int. Cl. B29D 99/00; H01Q 15/16

(52) U.S. Cl. CPC B29D 99/005; H01Q 15/163; B29C 2793/0072

(57) ABSTRACT

Exemplary embodiments include systems and method for making a membrane surface having an axis of revolution using first and second mandrel having precise and accurate working surfaces. The systems and methods may also use gore material that are cut and positioned using the first and second mandrels and seamed together to create the membrane surface.

### PRIORITY

This application claims priority as a continuation of International Application PCT/US22/73270, published as WO 2023/279032, filed Jun. 29, 2022, which claims priority to U.S. Application No. 63/216,456, filed Jun. 29, 2021, each of which are incorporated herein.

### BACKGROUND

Physical objects that comprise membrane surfaces may be made of sections (gores) that are connected together. This method of creating membrane surfaces are likely used when the physical object includes a membrane surface of revolution. In this case, the gores are positioned and revolve about an axis and are coupled together to create the final desired geometry. An example of such surfaces is a beach ball, or an antenna. FIGS. 1A-1C illustrate an exemplary antenna having membrane surfaces of revolution made of gores that are seamed together. As illustrated, a metal-coated membrane surface of revolution is in a parabolic shape. Such configurations may be used as an antenna or a solar concentrator. The example shown in FIGS. 1A-1C is an inflatable parabolic antenna of the Cassegrain type.

In some applications, e.g., the use of inflatable membrane antennas 100 for space, such as that shown in FIGS. 1A-1C, the membrane surface 102, 104 is desired to be as close to a parabolic surface of revolution as possible. However, in practice, the gores 106 that are used are flat rather than doubly-curved (curved in three dimensional space, such as about an orthogonal axis) because flat gores are less expensive to make. The use of flat gores can provide the requisite curvature in the meridional direction but the absence of curvature transverse to the meridian means that the surface points internal to the gore are some distance away from the ideal parabolic surface. A meridian line is analogous to the lines of longitude in a globe. In the case shown in FIGS. 1A-1C, the meridional direction is along the radial ribs 108.

The fact that the gores are flat along one direction is a source of antenna surface inaccuracy. The number of gores can be increased to increase surface accuracy but there is a practical limit to the maximum number of gores that can be used. Internal pressure can provide the missing curvature, and this moves the surface closer to the ideal shape. However, the fact that the gores were made initially flat will always dictate that the final surface will maintain inaccuracies.

### SUMMARY

Exemplary embodiments described herein may comprise methods and system to fabricate precise and accurate surfaces using discrete gores. Exemplary embodiments of the systems and methods described herein may be applicable to any surface of revolution, for example, parabola, sphere, etc.

### DRAWINGS

FIGS. 1A-1C illustrate different prospective views of a reflector that can be created from exemplary embodiments of the methods and systems described herein.

FIG. 2 illustrates an exemplary system according to embodiments described herein.

FIGS. 3-9 illustrate exemplary steps of a method according to embodiments described herein.

FIG. 10 illustrates exemplary features of the system according to embodiments described herein.

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Exemplary embodiments including methods and systems described herein include gores for making a membrane surface revolution that can use gores that are initially flat. The fact that the gores were made initially flat will always dictate that the final surface will maintain inaccuracies. However, exemplary embodiments of the system described herein may be used according to the methods described herein to reduce and minimize other sources of surface inaccuracies to achieve an accurate antenna despite the limitations imposed by the initial gore structure. Exemplary embodiments may be used to reduce surface inaccuracies from any combination of: gore width error along the length; gore length error; and gaps and overlaps in seaming the gores edge-to-edge. Gaps and overlaps in seaming are likely to occur as gores are usually seamed together by a person and done on a separate surface mandrel. For space antennas, gaps or overlaps on the order of a few thousandths of an inch can result in an overall surface inaccuracy that no longer meets the requirement.

Exemplary embodiments described herein include the use of a rigid accurate seaming mandrel that dramatically reduces the seaming error to a value determined solely by how accuracy of the mandrel. Precision and accuracies on the order of one ten thousandth of an inch is achievable on numerically controlled machined mandrels made of metal.

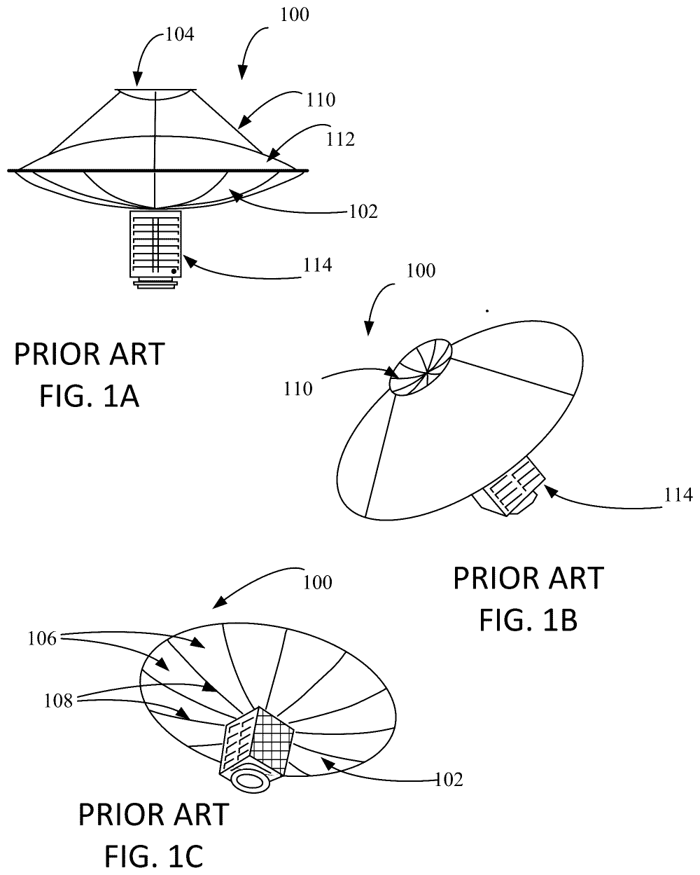

FIGS. 1A-1C illustrate different prospective views of a reflector that can be created more accurately from exemplary embodiments of the methods and systems described herein. FIGS. 1A-1C illustrate a membrane surface of revolution that may be made of individual gores that are coupled together according to methods described herein and using the systems described herein. The Cassegrain antenna shown includes a secondary reflector that could also be made of membrane gores according to embodiments described herein.

The inflatable membrane antenna 100 illustrated in FIG. 1 includes a reflector made of a membrane surface 102, a secondary reflector made of a membrane surface 104, canopy 112, and hub 114. The antenna may comprise support structures 110, and the membrane surface may be made of ribs 108 and gores 106.

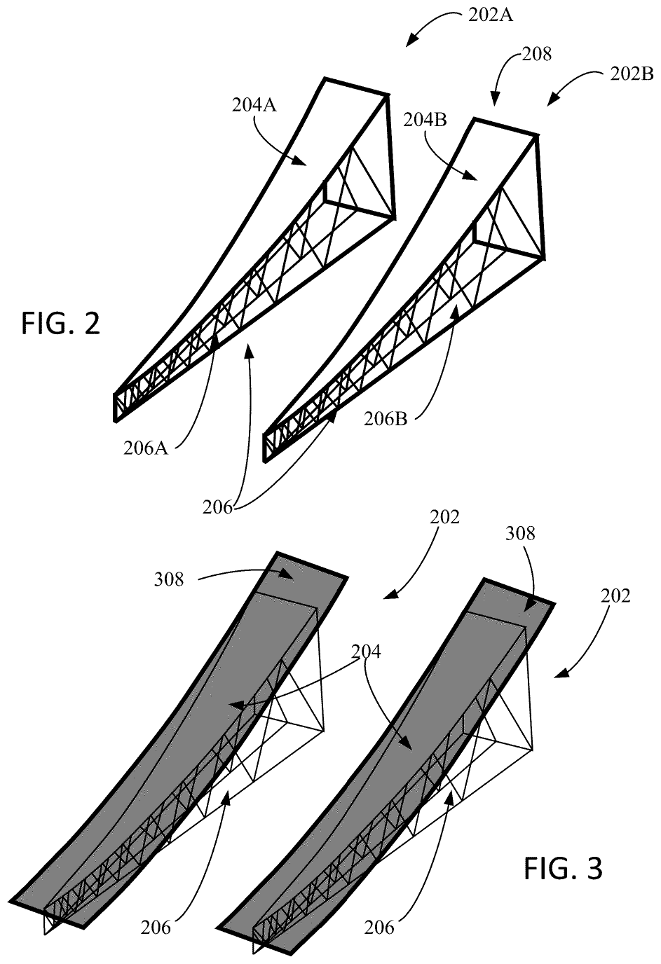

Exemplary embodiment(s) described herein may include devices and methods having a pair of accurately- and precisely-machined mandrels 202. For example, as illustrated in FIG. 2, a system 200 may provide a first mandrel 202A and a second mandrel 202B. Each mandrel may include a working surface 204, such as first mandrel 202A has a first working surface 204A and second mandrel 202B has a second working surface 204B. Each mandrel 202 may also have a support structure 206, such as first mandrel 202A has a first support structure 206A and second mandrel 202B has second support structure 206B.

In an exemplary embodiment, each mandrel 202 has a working surface 204. The first working surface 204A and the second working surface 204B may be the identical size and shape. In an exemplary embodiment, the mandrels 202 comprises a working surface 204 in a wedge shape. The wedge shape may be defined with a working surface width that is gradually and continuously greater as the working surface is traversed from one side to an opposite side of the mandrel. In an exemplary embodiment, the working surface 204 is curved about a single axis. For example, the working surface 204 is flat along a circumferential direction and curved along a radial (meridional) direction, where the circumferential direction is perpendicular to the radial direction. In an exemplary embodiment, the axis of rotation influences an elevation to the working surface. The working surface at a minimal width dimension may correspond to a lower elevation of the working surface on the mandrel, while the curvature of the working surface progressively elevates the working surface as the working surface also tapers outward and has a greater width dimension. The working surface may define a highest elevation and greatest width at a terminal end of the mandrel and a lowest elevation and minimal width at an opposing terminal end of the mandrel, opposite the terminal end. In an exemplary embodiment, the curvature of the mandrel working surface may be a desired functional shape, including any combination of: part of a parabolic shape, part of an elliptic shape, part of a circular shape, etc.

Exemplary embodiments comprise machining the working surface to precise and accurate shape for the gore. In an exemplary embodiment, the identity of the working surfaces between the two mandrels may be determined based on the tolerance acceptable for the final product. For example, if a tolerance for the resulting attachment of the gores is one ten thousandth of an inch, then the comparison of the first mandrel to the second mandrel for determining whether the surfaces are identical may be within a tolerance of one ten thousandth of an inch. If a greater tolerance is permitted, then the variation may similarly be permitted while remaining within the indented duplication of the first and second mandrel.

In an exemplary embodiment, the mandrels 204 may also comprise a support structure 206. In an exemplary embodiment the support structure 206A of the first mandrel 202A may be identical to the second support structure 206B of the second mandrel 202B. Again, the identity of the mandrels, working surfaces, and/or support structures may be determined based on the tolerance permitted by the application and the resulting product manufactured using the mandrels.

In an exemplary embodiment, the support structures may include additional components for assisting in the alignment of one mandrel to another mandrel. For example, the mandrels may comprise a visual indicator, such as a lever, and mated surface structure, or simply in the shape of the mandrel, support structure, and/or working surface that permits a user to accurately position one mandrel relative to the second mandrel.

In an exemplary embodiment, the support structures may permit adjustment of the mandrels relative to each other and/or to the environment. For example, the mandrels may comprise levelling components to adjust a relative height of the mandrels relative to the ground level. The levelling components may permit the mandrels to tilt, rotate, and/or translate vertically. The mandrels may comprise indicators for alignment, such as levelers, orientation indicators, sensors, etc. for the proper alignment of one mandrel to another. Exemplary embodiments also include the precise and accurate machining of each mandrel so the mandrels are identical. The identity of the mandrels may permit the two mandrels to be positioned and used as described herein in order properly and precisely align the respective mandrels.

Exemplary embodiments described herein include a two-gore mandrel as shown in FIG. 2. The duplicity of the mandrels permits the mandrels to be used as both the cutting and seaming mandrel at the same time. After a gore is cut on the mandrel, a second gore is cut on the second mandrel that is adjacent to the first. Hence, the two gores are lying next to each other and overlap and gaps at the seam are effectively rendered non-existent. The two gores are then seamed together with tape. The process is repeated to the last seam.

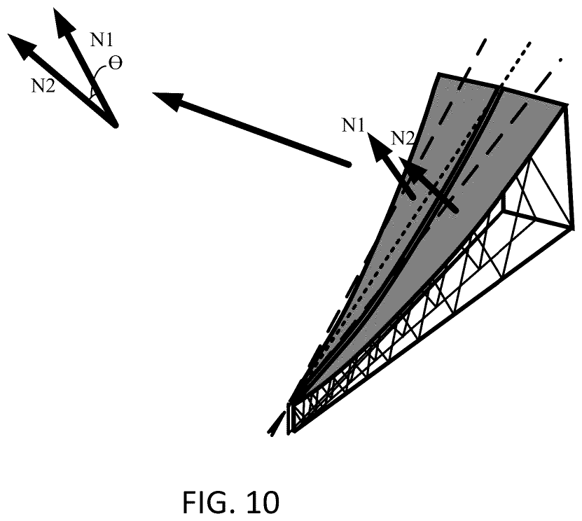

In an exemplary embodiment, the working surfaces and the support structures may be precisely and accurately machined to create a desired precision of a gore created using the mandrel. The relative positions of the mandrels may similarly be accurate and precise through the identity (being the same or identical) of the supporting structure. Each of the working surfaces may be supported on the support structure such that the working surfaces may be rotated about an axis of rotation. The axis of rotation (dashed line in FIG. 10) may be through a middle of the working surface through opposing terminal ends of the working surface at the tip and end of the mandrel, and through an axis of symmetry of the mandrel. The axis of rotation (fine dotted line in FIG. 10) may be through a terminal edge of the working surface. The rotation may be precisely controlled to permit accurate relative alignment of one working surface to the adjacent working surface. For the example of an axis of rotation about the terminal end of the mandrel, the terminal end of the mandrel may be rotationally fixed. The opposing terminal end of the mandrel may comprise a micrometer (or other appropriately sized rotational controller) to raise and/or lower the opposing terminal end of the mandrel by a specific amount, thus rotating the working surface and orienting the surface normal of one of the mandrels relative to the other mandrel. Exemplary embodiments may include additional or alternate axis of rotation. For example, the axis of rotation may be perpendicular to the axis of rotation of FIG. 10 (dashed line) and be about a tip or end of the mandrel. Similar to the previous axis of rotation, the tip may be fixed, while a micrometer or other translation device is used to raise the opposite end of the mandrel working surface. In this case, however, the translation device is along the axis of symmetry such that the rotation is about the tip as the entire terminal end is raised or lowered relative to the tip.

In an exemplary embodiment, the mandrel may include a threated hole having threads of a desired size for the desired rotational precision. A post may extend and be threadingly mated to the hole. The post may engage the working surface such that as the post is rotated and is threaded through the hole, the working surface is elevated and lowered by the desired amount. The working surface may be rotationally fixed at an axis, and therefore the movement of the working surface through the translation of the post may rotationally move the working surface. The threading may permit the orientation to be controlled at a micrometer dimension. A similar arrangement may be used by offsetting the axis of rotation through the middle of the working surface and permitting one side of the working surface to be controlled by the micrometer (or other dimensional threaded post), while the opposing side of the working surface on the opposite side of the axis of rotation may be permitted to move in the opposite rotational direction (up or down) in an equal amount (i.e. rotate about the rotational axis).

In an exemplary embodiment, the working surfaces of the mandrels are created from precisely machined metal having a specified precision according to the requirements of the resulting structure being created on the mandrels. The specified precision may be tenths of an inch, hundredths of an inch, thousandths of an inch, and/or may be on the order of millimeters, micrometers, etc.

The two-gore mandrel comprise an outer section 208, the widest and farthest from the vertex (tip), that can be shaped and marked with fiduciaries defining where the outer edge of the gores need to be stretched to define the final inflated shape. The outer section may be used when the gore edge needs to be stretched wider (along the hoop direction) to define the configuration in its final inflated shape. The outer section 208 may be used to stretch the outer gore points after all of the gores have been seamed together.

FIGS. 3-9 illustrate exemplary steps according to the method of manufacturing a structure using the mandrels described herein.

At the first step, FIG. 3, a first and second gore material 308 is positioned on each of the two mandrels 202A and 202B, as described herein. The two mandrels may be identical as described herein, and/or a working surface of each of the two mandrels may be identical. In an exemplary embodiment, each of the two mandrels comprises a working surface. The working surface may define a curvature along at least one axis. The gore materials are positioned over and on the working surfaces 204 of the respective mandrels. A first gore material is positioned on a first working surface of a first mandrel and a second gore material is positioned on a second working surface of a second mandrel. The first gore material and second gore material may comprise a sheet. The first gore material and second gore material may also be in a geometric shape other than the gore shape, such as in a raw material shape including, for example, rectangular or square. As seen in FIG. 3, the first gore material and second gore material are positioned on and in contact with the working surface of the respective first mandrel and second mandrel. When the gore material is in contact with the working surface, the gore may be conformed to the working surface such that the gore in its raw, original form (being a planar sheet) is curved about a circumferential (cross or transverse) axis.

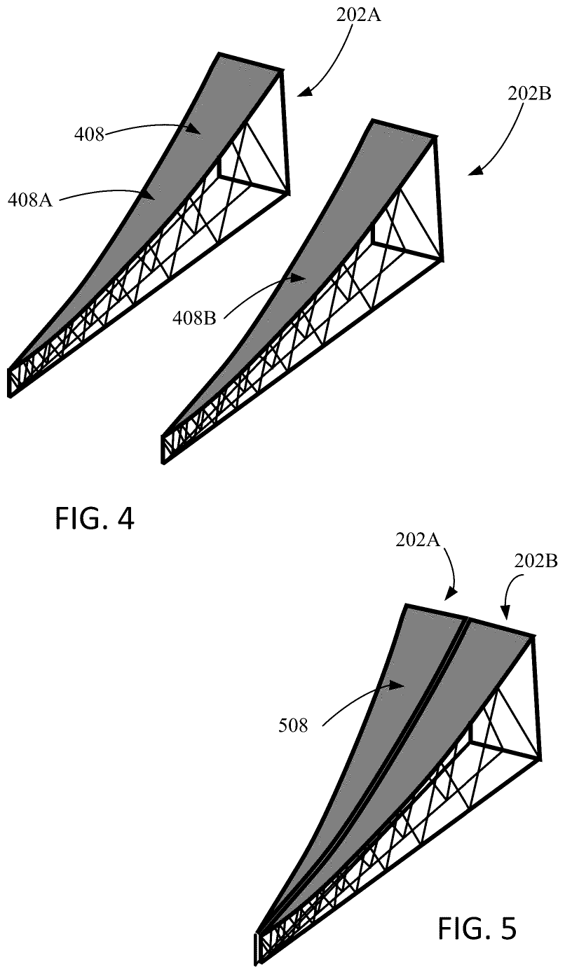

At step 2, FIG. 4, each of the gore materials may be trimmed based on the working surface of the respective mandrels. The resulting gore materials, when cut according to the shape of the mandrel, defines two gores 408, a first gore 408B cut from the first gore material 308 on the first mandrel 202A and the second gore 408B cut from the second gore material 308 on the second mandrel 202B.

At the third step, FIG. 5, the mandrels may be aligned and the gores seamed together. As illustrated, a terminal lateral edge of the first gore 408A is positioned in contact with a terminal lateral edge of the second gore 408B. The first mandrel 202A and second mandrel 202B are aligned and positioned in contact with each other so that the first gore and second gore are precisely and accurately positioned relative to each other for coupling. When properly positioned, the first gore 408A and second gore 408B may be seamed together at their common edge to create a gore composite section 508.

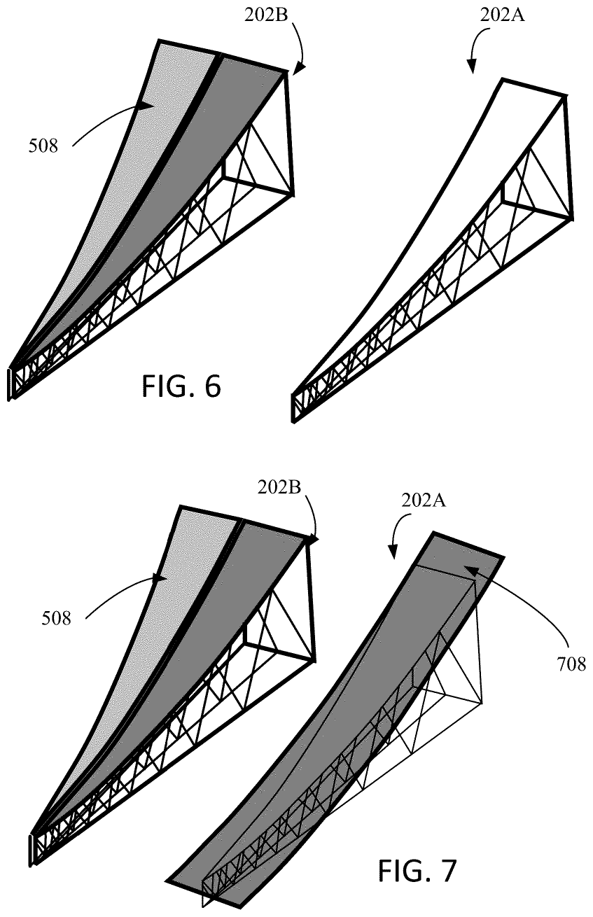

At step 4, FIG. 6, one of the mandrels may be moved from under a portion of the gore composite section to the opposite side of the other mandrel so that one mandrel is no longer under the gore composite section and the other mandrel is supporting the gore composite section in preparation of attaching another gore to the gore composite section. As illustrated, the first mandrel 202A is removed from a first side of the second mandrel 202B under the gore composite section 508 to a second side of the second mandrel 202B, opposite the first side. The second mandrel 202B is still positioned at an edge of the gore composite section 508 and supports at least a portion of the gore composite section 508. Other materials and/or structures may be used to support the overhanging gore composite section for stability. The first mandrel 202A is removed from under the gore composite structure in preparation of preparing another gore material.

At step 5, FIG. 7, a new gore material is prepared for attaching to the gore composite section. As illustrated, a new gore material 708 is positioned on the first mandrel 202A. The new gore material 708 may be similar to or the same as the gore material used at step 1 in FIG. 3. The new gore material may be provided in an originally or raw planar, sheet form. The new gore material 708 may be conformed to the working surface of the first mandrel 202A.

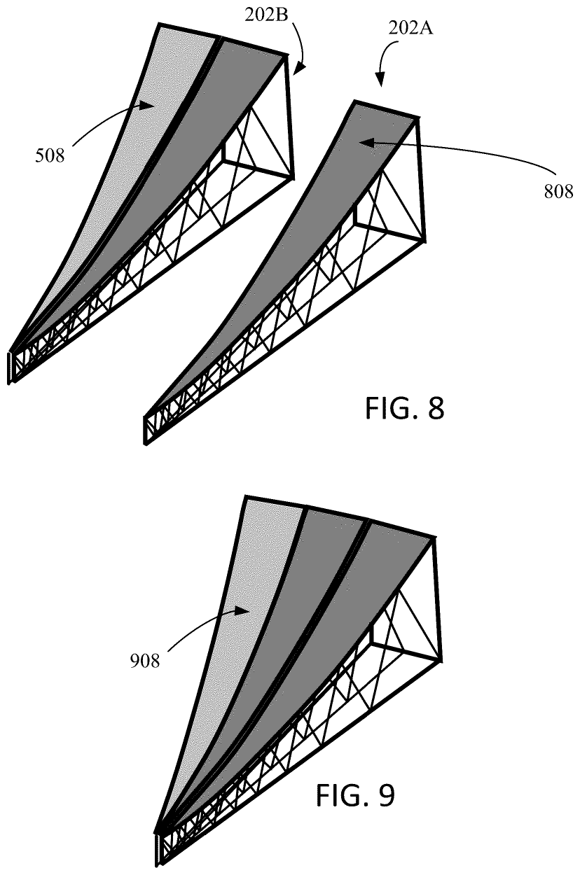

At step 6, FIG. 8, the new gore material 708 may be trimmed using the first mandrel 202A to create a new gore 808. The gore composite section 508 may still be supported by the second mandrel 202B.

At step 7, FIG. 9, the new gore is coupled to the gore composite section to create a larger composite section. As illustrated, as similar to the process illustrated in FIGS. 4-5, the first mandrel 202A is brought into contact with the second mandrel 202B such that the first mandrel and the second mandrel are precisely and accurately aligned. The alignment of the mandrels may bring a lateral edge of the new gore 808 in contact with a lateral, terminal edge of the gore composite section and properly, precisely, and accurately align the new gore to the gore composite section. Once aligned, the new gore may be seamed to the gore composite section to create a larger composite section 9.

The process may thereafter be repeated by removing one mandrel from under the composite section to the opposite side of the remaining mandrel supporting the composite section, preparing a new gore material by trimming the gore material using the moved mandrel, and aligning the two mandrels again to align the new gore with the larger composite section and attaching the new gore to the larger composite section. The process therefore iteratively creates larger composite sections until the full revolution or the final desired shape of the composite structure is realized.

Instead of just being the shape of a single gore, the two mandrels side by side may be exactly the shape of two gores together and with the requisite angular orientations between them. This is illustrated in FIG. 10. As illustrated, the working surface of the first mandrel may be oriented relative to the working surface of the second mandrel such that the surface normal of the respective working surfaces are non-zero, or not parallel. The surface normal of the first mandrel, N1, is shown and the surface normal of the second mandrel, N2, is shown. When the surface normals are brought together to share a common vertex, the angle θ between them is apparent, as illustrated in FIG. 10. The surfaces may be positioned relative to each other such that the surface created traversing across the two mandrels creates a shallow “v” or approximates a concave shape to generate the third dimensional approximation of curvature for the resulting surface of the final structure.

The two gore mandrels may be designed to be joined at and able to rotate about an axis passing through the common tip. This axis may be parallel to the axis of the surface of revolution. The rotation may permit the respective working surface of the mandrels to be positioned to create a non-planar attachment of the respective gore portions so that the resulting composite structure approximates a second axis of curvature according to embodiments described herein. As described herein, the mandrels may comprise actuators, controllers, sensors, and measurement devices such that the relative position of the working surfaces may be accurately and precisely positioned relative to each other.

In an exemplary embodiment, the working surfaces and the support structures may be precisely and accurately machined to create a desired precision of a gore created using the mandrel. The relative positions of the mandrels may similarly be accurate and precise through the identity of the supporting structure. Each of the working surfaces may be supported on the support structure such that the working surfaces may be rotated about an axis of rotation. The axis of rotation (dashed line in FIG. 10) may be through a middle of the working surface aligned with opposing terminal ends of the working surface at the tip and end of the mandrel. The axis of rotation (fine dotted line in FIG. 10) may be through a terminal edge of the working surface. The rotation may be precisely controlled to permit accurate relative alignment of one working surface to the adjacent working surface. For the example of an axis of rotation about the terminal end of the mandrel. The terminal end of the mandrel may be rotationally fixed. The opposing terminal end of the mandrel may comprise a micrometer to raise and/or lower the opposing terminal end of the mandrel by a specific amount, thus rotating the working surface and orienting the surface normal of one of the mandrels relative to the other mandrel. In an exemplary embodiment, the mandrel may include a threated hole having threads of a desired size for the desired rotational precision. A post may extend and be threadingly mated to the hole. The post may engage the working surface such that as the post is rotated and is threaded through the hole, the working surface is rotated by the desired amount. The threading may permit the orientation to be controlled at a micrometer dimension. A similar arrangement may be used by offsetting the axis of rotation through the middle of the working surface and permitting one side of the working surface to be controlled by the micrometer (or other dimensional threaded post), while the opposing side of the working surface on the opposite side of the axis of rotation will move in the opposite rotational direction (up or down) and an equal amount.

Exemplary embodiments of the method described herein may include rotationally positioning the respective working surfaces of each mandrel relative to the other before seaming the gore(s). For example, at steps associated with FIGS. 4-5, and 8-9, once the new gore is cut and positioned adjacent to the gore section, the working surfaces of the mandrels may be rotationally positioned to a desired relative orientation to each other. The gores and/or gore sections supported by the respective mandrels may be coupled together. The coupling of the gores may be through conventional attachment methods based on the materials being coupled. For example, the gores may be taped, adhered, bonded, sewn, etc.

In an exemplary embodiment, the working surfaces of the mandrels are created from precisely machined metal having a specified precision according to the requirements of the resulting structure being created on the mandrels. The specified precision may be tenths of an inch, hundredths of an inch, thousandths of an inch, and/or may be on the order of millimeters, micrometers, etc.

Exemplary embodiments of the methods described herein may include a method for making a membrane surface having an axis of revolution, including providing a first mandrel having a first working surface and a second mandrel having a second working surface; providing a first gore material and a second gore material, wherein the first gore material and the second gore material are flat; positioning the first gore material over the first working surface and the second gore material over the second working surface; aligning the first mandrel with the second mandrel and seaming the first gore material to the second gore material.

In an exemplary embodiment, the first working surface is identical to the second working surface and each working surface is curved about a first axis and straight in second axis, the second axis perpendicular to the first axis.

In an exemplary embodiment, the positioning of the first gore material on the first working surface and the second gore material on the second working surface comprises positioning each gore material on and in contact with each working surface respective so that the gore material conforms to the work surface.

In an exemplary embodiment, the first gore material that is provided is flat and is larger than the first working surface so that the first gore material extends past a first perimeter of the first working surface when the first gore material is positioned over the first working surface, and the second gore material that is provided is flat and is larger than the second working surface so that the first gore material extends past a second perimeter of the second working surface when the second gore material is positioned over the second working surface. Exemplary embodiments of the method may also include cutting the first gore material to a first gore using the first working surface as a first cutting template and cutting the second gore material to a second gore using the second working surface as a second cutting template.

In an exemplary embodiment, seaming the first gore material to the second gore material comprises aligning the first mandrel with the second mandrel and seaming the first gore to the second gore after the first gore material and the second gore material are cut to create a gore composite. In an exemplary embodiment, seaming may including positioning the first gore adjacent and aligned with the second gore and using a tape or additional material overlapping a portion of the first gore and the second gore to attach the first gore to the additional material and the second gore to the additional material. Seaming may also include bonding, adhesives, threading, etc.

In an exemplary embodiment, the first mandrel and the second mandrel comprise less than half the revolution of the membrane surface.

In an exemplary embodiment, the method may also include moving the first mandrel from under the first gore material on a first side of the second mandrel; providing a third gore material on the first working surface; cutting the third gore material using the first working surface as the first cutting template to create a third gore; and repositioning the first mandrel on an opposite side of the second mandrel from the first side, while the second gore material remains on the second mandrel; and seaming the third gore to the gore composite creating an updated gore composite.

In an exemplary embodiment, the method may also include continually moving the second mandrel and then the first mandrel from under the updated gore composite and using either the second mandrel and then first mandrel as a template for cutting a new gore, seaming the new gore to the updated gore composite until the revolution of the membrane surface is complete, and seaming the first gore to a last gore together using the first mandrel and the second mandrel.

In an exemplary embodiment, the method may also include: rotating the first working surface, the second working surface, or both the first working surface and the second working surface to align the first working surface to the second working surface.

In an exemplary embodiment, the method may also include: leveling the first working surface and the second working surface to align the first working surface to the second working surface.

In an exemplary embodiment, the method may also include: stretching a first gore material on the first mandrel and/or a second gore material on the second mandrel.

Exemplary embodiments described herein may include a system for making a membrane surface having an axis of revolution, comprising: a first mandrel having a first working surface; a second mandrel having a second working surface, wherein the first working providing a first mandrel having a first working surface and a second mandrel having a second working surface.

In an exemplary embodiment, the system may include a first gore material and a second gore material, wherein the first gore material and the second gore material are flat.

In an exemplary embodiment, the first working surface is curved about a first axis and straight along a second axis perpendicular to the first axis, and the second working surface is curved about a third axis and straight along a fourth axis perpendicular to the third axis.

In an exemplary embodiment, the first mandrel comprising a first rotation mechanism configured to rotate the first working surface, and the second mandrel comprises a second rotation mechanism configured to rotate the second working surface.

In an exemplary embodiment, the first mandrel comprises a first leveling mechanism configured to level the first working surface, and the second mandrel comprises a second leveling mechanism configured to level the second working surface.

In an exemplary embodiment, the first working surface is in a first shape of a first wedge and the second working surface is in a second shape of a second wedge.

In an exemplary embodiment, the first working surface and the second working surface comprises metal and is configured to a precise and accurate shape.

In an exemplary embodiment, the first gore material and the second gore material comprises sheet membranes for a membrane surface.

As used herein, the terms “about,” “substantially,” “approximately”, and even “identical” for any numerical values, ranges, shapes, distances, relative relationships, etc. indicate a suitable dimensional tolerance that allows the part or collection of components to function for its intended purpose as described herein. Numerical ranges may also be provided herein. Unless otherwise indicated, each range is intended to include the endpoints, and any quantity within the provided range. Therefore, a range of 2-4, includes 2, 3, 4, and any subdivision between 2 and 4, such as 2.1, 2.01, and 2.001. The range also encompasses any combination of ranges, such that 2-4 includes 2-3 and 3-4.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. Specifically, exemplary components are described herein. Any combination of these components may be used in any combination. For example, any component, feature, step or part may be integrated, separated, sub-divided, removed, duplicated, added, or used in any combination and remain within the scope of the present disclosure. Embodiments are exemplary only, and provide an illustrative combination of features, but are not limited thereto.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. Method for making a membrane surface having an axis of revolution, comprising:
providing a first mandrel having a first working surface and a second mandrel having a second working surface;
providing a first gore material and a second gore material, wherein the first gore material and the second gore material are flat;
positioning the first gore material over the first working surface and the second gore material over the second working surface;
aligning the first mandrel with the second mandrel and seaming the first gore material to the second gore material.

2. The method of claim 1, wherein the first working surface is identical to the second working surface and each working surface is curved about a first axis and straight in second axis, the second axis perpendicular to the first axis.

3. The method of any of the preceding claims, wherein the positioning of the first gore material on the first working surface and the second gore material on the second working surface comprises positioning each gore material on and in contact with each working surface respective so that the gore material conforms to the work surface.

4. The method of any of the preceding claims, wherein the first gore material that is provided is flat and is larger than the first working surface so that the first gore material extends past a first perimeter of the first working surface when the first gore material is positioned over the first working surface, and the second gore material that is provided is flat and is larger than the second working surface so that the first gore material extends past a second perimeter of the second working surface when the second gore material is positioned over the second working surface, and the method further comprising cutting the first gore material to a first gore using the first working surface as a first cutting template and cutting the second gore material to a second gore using the second working surface as a second cutting template.

5. The method of any of the preceding claims, wherein seaming the first gore material to the second gore material comprises aligning the first mandrel with the second mandrel and seaming the first gore to the second gore after the first gore material and the second gore material are cut to create a gore composite.

6. The method of any of the preceding claims, wherein the first mandrel and the second mandrel comprise less than half the revolution of the membrane surface, the method further comprising:
moving the first mandrel from under the first gore material on a first side of the second mandrel;
providing a third gore material on the first working surface;
cutting the third gore material using the first working surface as the first cutting template to create a third gore;
and repositioning the first mandrel on an opposite side of the second mandrel from the first side, while the second gore material remains on the second mandrel;
seaming the third gore to the gore composite creating an updated gore composite.

7. The method of any of the preceding claims, further comprising: continually moving the second mandrel and then the first mandrel from under the updated gore composite and using either the second mandrel and then first mandrel as a template for cutting a new gore, seaming the new gore to the updated gore composite until the revolution of the membrane surface is complete, and seaming the first gore to a last gore together using the first mandrel and the second mandrel.

8. The method of any of the preceding claims, further comprising: rotating the first working surface, the second working surface, or both the first working surface and the second working surface to align the first working surface to the second working surface.

9. The method of any of the preceding claims, further comprising: leveling the first working surface and the second working surface to align the first working surface to the second working surface.

10. The method of any of the preceding claims, further comprising: stretching a first gore material on the first mandrel and/or a second gore material on the second mandrel.

11. A system for making a membrane surface having an axis of revolution, comprising:
a first mandrel having a first working surface;
a second mandrel having a second working surface, wherein the first working providing a first mandrel having a first working surface and a second mandrel having a second working surface.

12. The system of claim 11, further comprising a first gore material and a second gore material, wherein the first gore material and the second gore material are flat.

13. The system of any of the claims 11-12, wherein the first working surface is curved about a first axis and straight along a second axis perpendicular to the first axis, and the second working surface is curved about a third axis and straight along a fourth axis perpendicular to the third axis.

14. The system of any of the claims 11-13, wherein the first mandrel comprising a first rotation mechanism configured to rotate the first working surface, and the second mandrel comprises a second rotation mechanism configured to rotate the second working surface.

15. The system of any of the claims 11-14, wherein the first mandrel comprises a first leveling mechanism configured to level the first working surface, and the second mandrel comprises a second leveling mechanism configured to level the second working surface.

16. The system of any of the claims 11-15, wherein the first working surface is in a first shape of a first wedge and the second working surface is in a second shape of a second wedge.
